(19) United States
(12) Patent Application Publication
(10) Pub. No.: US 2026/0163820 A1
(43) Pub. Date: Jun. 11, 2026

(54) ALLOCATING COMPUTING TASKS TO RADIO NETWORK NODES

(71) Applicant: Telefonaktiebolaget LM Ericsson (publ), Stockholm (SE)

(72) Inventors: Hossein SHOKRI GHADIKOLAEI, Taby (SE); Lackis ELEFTHERIADIS, Valbo (SE); Burak DEMIREL, Alvsjo (SE); Amin AZARI, Jarfalla (SE); Zere BRETENSAE, Trangsund (SE)

(21) Appl. No.: 18/707,381

(22) PCT Filed: Nov. 3, 2021
(86) PCT No.: PCT/EP2021/080561

§ 371 Date: May 3, 2024

(51) Int. Cl. H04L 41/22; H04L 67/141

(52) U.S. Cl. CPC H04L 41/22; H04L 67/141

(57) ABSTRACT

A method (500) for allocating computing tasks to one or more radio network nodes in a communication network is disclosed. The method comprises obtaining (502) node performance data indicative of operational performance of respective radio network node of the one or more radio network nodes. The method further comprises, based on the obtained node performance data, generating (504) a node energy index for respective node of the one or more radio network nodes, the node energy index being indicative of energy efficiency of the respective node of one or more radio network nodes in a given time window. The method further comprises initiating (506) allocation of a computing task to a radio network node of the one or more radio network nodes, wherein the allocation is based on the generated node energy index.

### TECHNICAL FIELD

Embodiments of the present disclosure relate to computer-implemented methods, nodes and communication networks related to allocating computing tasks and, in particular, to computer-implemented methods, nodes and communication networks for allocating computing tasks to one or more radio network nodes.

### BACKGROUND

State-of-the-art artificial intelligence (AI) models can achieve impressive prediction accuracy at the expense of using astonishingly large model sizes, big datasets, distributed computations, and resource-intensive communications between participating computational devices. These operations and circumstances typically result in large energy usage and significant carbon footprint.

Mobile communications sector is not an exception due to ever-increasing demands for data collection required for training of AI models. Furthermore, new network services often require improved training of large models, and computations distributed at various levels. Considering a mobile network architecture, the energy usage and carbon footprint are expected to substantially increase due to a growing interest in shifting computations to edge nodes with edge learning, privacy-preserving algorithms, distributed AI and adoption of massive Internet-of-Things (IoT).

Vandikas et al, “Ensuring energy-efficient networks with artificial intelligence”, Ericsson Technology Review, 13 Apr. 2021 proposed an AI-based architecture to recommend energy-efficient configuration settings to network nodes.

### SUMMARY

The energy usage and carbon footprint associated with above-described operations in mobile networks are heavily dependent on the power source usage of participating radio network nodes or radio base stations (RBSs) and on the related architecture. Moreover, the energy consumption of an RBS is a function of its traffic variation, its radio access technologies, as well as communication technology used to connect it to the core network.

Different locations in the network may be loaded differently, for example radio traffic at some RBSs, such as the ones servicing a sports stadium during a sports event may be greater than radio traffic at a macro RBS in a remote location. For this reason, there will be variations in energy level used by these RBSs during their operation.

When energy to the RBS is supplied from batteries, or from some other energy source that is fossil fuel free and/or renewable, the carbon footprint of the RBS is reduced. Similarly, when communication technologies used at the RBS and its particular configuration allow a higher bits/joule communication, the total carbon footprint can be further reduced. The existing solutions optimizing allocation of computing tasks in radio networks do not consider the associated carbon footprint.

The existing works attempt to design the distributed AI orchestrator for the communication efficiency. However, when executing a computing task such as solving a machine learning problem over a network like cellular, mobile or Internet of Things (IoT) network, a key technical consideration is total energy usage rather than just the number of algorithm iterations or bits involved.

In accordance with a first aspect, a method for allocating computing tasks to one or more radio network nodes in a communication network is disclosed. The method comprises obtaining node performance data indicative of operational performance of respective radio network node of the one or more radio network nodes. The method further comprises, based on the obtained node performance data, generating a node energy index for respective node of the one or more radio network nodes, the node energy index being indicative of energy efficiency of the respective node of one or more radio network nodes in a given time window. The method further comprises initiating allocation of a computing task to a radio network node of the one or more radio network nodes, wherein the allocation is based on the generated node energy index.

In accordance with a second aspect, an apparatus for allocating computing tasks to one or more radio network nodes in a communication network is disclosed. The apparatus is configured to perform steps of the method according to the first aspect.

In accordance with a third aspect, an apparatus for allocating computing tasks to one or more radio network nodes in a communication network is disclosed. The apparatus comprises processing circuitry and a memory, said memory containing instructions executable by said processing circuitry whereby said apparatus is operative to perform steps of the method according to the first aspect.

In accordance with a fourth aspect, a communication network is disclosed. The communication network comprises one or more radio network nodes configured to generate respective node energy index indicative of energy efficiency of the respective node in a given time window, wherein the node energy index is generated based on node performance data indicative of operational performance of respective radio network node. The communication network further comprises an allocating node configured to obtain the node energy index, wherein the allocating node is further configured to initiate allocation of a computing task to a radio network node of the one or more radio network nodes, wherein the allocation is based on the obtained node energy index. The allocating node is further configured to send to a central node an indication of the radio network node allocated with the computing task, wherein the central node is configured to receive from the allocating node the indication of the radio network node allocated with the computing task, wherein the central node is further configured to send the computing task for execution to the indicated radio network node.

In accordance with a fifth aspect, a method performed by a central node in a communication network comprising one or more radio network nodes is disclosed. The method comprises obtaining node performance data indicative of operational performance of respective radio network node of the one or more radio network nodes. The method further comprises sending to an allocating node for allocation of computing tasks to the one or more radio network nodes, a node energy index indicative of energy efficiency of the respective node of one or more radio network nodes in a given time window, the node energy index being generated based on the obtained node performance data. The method further comprises receiving, from the allocating node, an indication of a radio network node allocated with a computing task. The method further comprises sending the computing task for execution to the indicated radio network node.

In accordance with a sixth aspect, a central node in a communication network comprising one or more radio network nodes is disclosed. The central node is configured to perform steps of the method according to the fifth aspect.

In accordance with a seventh aspect, a central node in a communication network comprising one or more radio network nodes is disclosed. The central node comprises processing circuitry and a memory, said memory containing instructions executable by said processing circuitry whereby said apparatus is operative to perform steps of the method according to the fifth aspect.

In accordance with an eighth aspect, a method performed by an allocating node in a communication network comprising one or more radio network nodes is disclosed. The method comprises receiving, from a central node, a node energy index indicative of energy efficiency of the respective node of the one or more radio network nodes in a given time window. The method further comprises initiating allocation of a computing task to a radio network node of the one or more radio network nodes, wherein the allocation is based on the received node energy index. The method further comprises sending to the central node an indication of the radio network node allocated with the computing task.

In accordance with a ninth aspect, an allocating node in a communication network comprising one or more radio network nodes is disclosed. The allocating node is configured to perform steps of the method according to eight aspect.

In accordance with a tenth aspect, an allocating node in a communication network comprising one or more radio network nodes is disclosed. The allocating node comprises processing circuitry and a memory, said memory containing instructions executable by said processing circuitry whereby said apparatus is operative to perform steps of the method according to eight aspect.

In accordance with an eleventh aspect, a computer program comprising instructions which, when executed on at least one processor, cause the at least one processor to carry out a method according to any of the first aspect, fifth aspect, or eight aspect.

In accordance with a twelfth aspect, a computer program product is disclosed. The computer program product comprises non transitory computer readable media having stored thereon a computer program according to any of the first aspect, fifth aspect, or eight aspect.

### BRIEF DESCRIPTION OF THE DRAWINGS

FIG. 1 shows an example topology of distributed computation infrastructure in a mobile network.

FIG. 2 shows an example ontology of a cell site of a mobile network.

FIG. 3 shows an example topology of a communication network.

FIG. 4 shows a communication network according to some embodiments of the disclosure;

FIG. 5 shows a distributed learning setting in a communication network according to some embodiments of the disclosure.

FIG. 6 shows a flowchart illustrating step of a method for allocating computing tasks according to embodiments of the disclosure.

FIG. 7 shows a flowchart illustrating step of a method performed by a central node according to embodiments of the disclosure.

FIG. 8 shows a flowchart illustrating step of a method performed by an allocating node according to embodiments of the disclosure.

FIG. 9 shows a block diagram of a network node according to some embodiments of the disclosure.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general-purpose computers. Nodes that communicate using the air interface also have suitable radio communications circuitry.

Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor, DSP hardware, a reduced instruction set processor, hardware (e.g., digital or analogue) circuitry including but not limited to application specific integrated circuit(s), ASIC and/or field programmable gate array(s), FPGA(s), and (where appropriate) state machines capable of performing such functions.

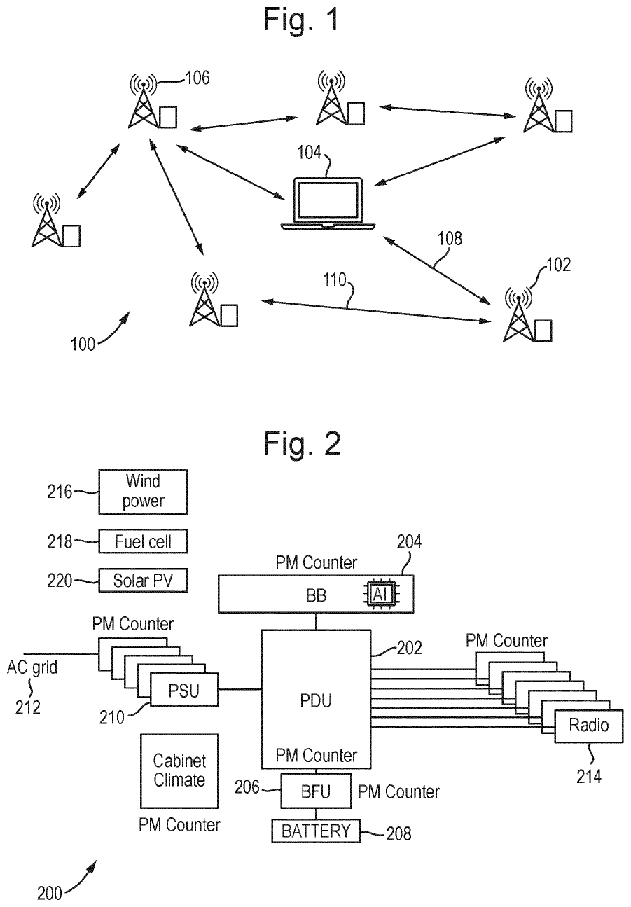

Allocation of computing tasks to one or more radio network nodes in a communication network is disclosed. The communication network may be a mobile network 100 as shown on FIG. 1. An example topology of a mobile network 100 is shown where computations may be distributed among different nodes 102, 106. The network 100 comprises one or more radio network nodes 102, 106, such as 3^{rd} Generation Partnership Project (3GPP) Evolved nodeB (eNodeB), 5th Generation NodeB (gNodeB) or IoT nodes such as constrained nodes. The radio network nodes 102, 106 may be part of a radio access network (RAN) where user equipment (UE, not shown) may communicate with the radio network nodes 102,106 via a wireless channel. The radio network nodes 102, 106 may communicate with each other, for example via a communication link 110. One of the nodes comprised in the network 100 may be an allocating node 104 such as an orchestrator 104. The orchestrator 104 may be a node belonging to Operations, Administration and Maintenance (OAM) function within the mobile network 100. The orchestrator 104 is configured to allocate computing tasks to other network nodes, such as radio network nodes 102, 106.

FIG. 2 shows an example ontology of a cell site of a mobile network, such as eNodeB or gNodeB 102, 106. The site may comprise a power distribution unit (PDU) 202 which may be a hardware card that may be located in a cabinet of a radio base station. The PDU 202 may be coupled with a baseband (BB) unit 204 and with a battery 208 via a battery fuse unit (BFU) 206. The BB unit 204 may contain processing and computing components, such as processing circuitries, memories, communication buses, that may be configured to execute various computing tasks. The PDU 202 may be further coupled with a plurality of power supply units 210, through which mains power may be supplied from the alternating current (AC) grid 212.

The PDU 202 may supply power to a plurality of radio units 214. Alternatively to AC grid 212 and battery 208, the power to the PDU 202 may be supplied from a wind power generating unit 216 such as a wind turbine, a fuel cell 218 such as a hydrogen fuel cell or solar power generating unit 220 such as a photovoltaic (PV) installation.

A computing task may be any processing or calculation operation to be performed by the computing resources of a network node. For example, the computing task may be executing an iteration of training of a machine learning model in a distributed machine learning setting or solving some local optimization problem to find some locally optimal parameters (e.g., in a federated learning setup) or processing some locally available data to find some particular patterns (including data summary, data statistics, data irregularity, etc.) and report them to the orchestrator.

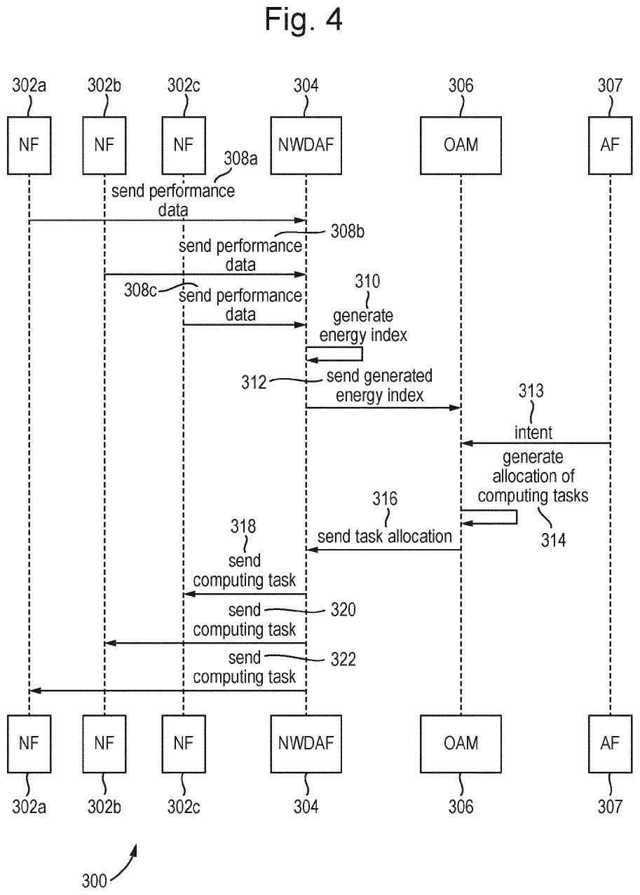

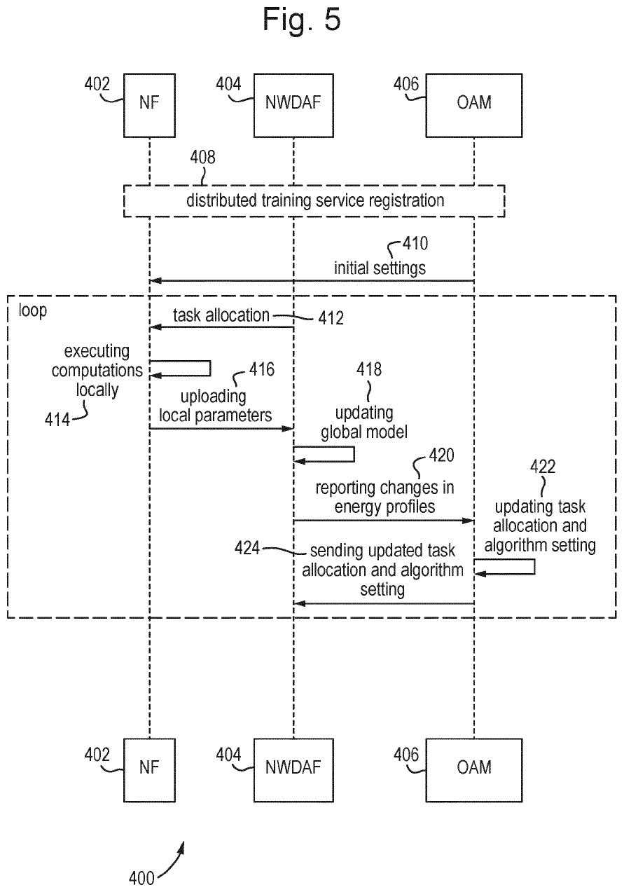

FIG. 4 shows a communication network 300 according to some embodiments, and FIG. 5 shows steps of the method 500 of allocating computing tasks according to embodiments. In step 308a, 308b, 308c, 502, 532 node performance data indicative of operational performance of respective radio network node of the one or more radio network nodes is obtained. In particular, one or more radio network nodes 302a, 302b, 302c may comprise respective Network Function (NF) that may collect and send 308a, 308b, 308c node performance data to a central node 600, such as to a Network Data and Analytics Function (NWDAF) node 304, 600. Alternatively, the node performance data may be obtained locally, for example by reading or loading pre-collected performance data from a memory or other storage in the same node.

The performance data may comprise energy source data indicative of characteristics of energy source used to power the respective radio network node. The radio network nodes 302a, 302b, 302c such as eNodeB or gNodeB, may be supplied from different sources of power, such as mains grid power, batteries or diesel generators. They may also be powered from renewable energy sources such as wind generators 216, fuel cells 218 or solar installations 220. For example, the energy source data may comprise a battery and the characteristics may comprise a battery capacity that may be expressed in ampere hours (AH). In one example, when the radio network node is powered from the mains grid, the characteristics of this energy source may comprise a fixed cost data expressed in a fixed cost per kWh. Alternatively, the cost may be time-location dependent and be calculated using a function that can be obtained from a utility provider. The energy source characteristics may further comprise voltage variation data (VAC) or current variation data (IAC).

The performance data may further comprise network traffic data associated with the respective radio network node. In case of radio traffic, the traffic data may comprise for example Physical Resource Block (PRB) usage data or Radio Resource Control (RRC) parameters. The network traffic data may further comprise information on a number of current connections, or information on data volume being exchanged. The skilled person will be aware of other network traffic indicators that may equally be used.

The node performance data may further comprise configuration data associated with the respective radio network node. In particular, the configuration data may comprise information on radio technology (RAT) being currently utilised by the radio network node, such as Global System for Mobile Communications (GSM), Wideband Code-Division Multiple Access (WCDMA), Long Term Evolution (LTE), New Radio (NR).

The performance data may further comprise other sensor or operational data, such as site temperature data (e.g. temperature outside and inside the racks), disc occupation, central processing unit (CPU) usage, memory usage, device profile and information (e.g. type of CPU or Graphics Processing Unit (GPU), clock, power saving modes), time and location data.

In some embodiments, computational capacity data of respective radio network node of the one or more radio network nodes is further obtained. The capacity data may comprise for example cache sizes, resource occupation information (e.g. CPU, memory). In some embodiments the computational capacity data may be comprised in the node performance data.

In step 310, 504, based on the obtained node performance data, a node energy index for respective node of the one or more radio network nodes is generated, the node energy index being indicative of energy efficiency of the respective node of one or more radio network nodes in a given time window. The generation of index may be performed in different nodes, depending on other business and technical considerations. For example, the generation of energy index may be performed locally in the radio network node 302a, 302b, 302c, in which case the performance data is collected locally from the respective node. Alternatively, the generation of energy index may be performed in the allocating node 304, such as NWDAF node 304, based on the performance data received 534 from respective node.

In a simplified form, as an example, the energy index E_{index} may be calculated as a weighted sum of the contributing factors:

$${E}_{index} = {\sum }_{i ∈ \{ factors \}} {w}_{i} {G}_{i} \qquad ( 1 )$$

wherein wᵢ and Gᵢ correspond to the weight and value of the ith factor, respectively. The contributing factor may correspond to node performance data. In some embodiments, the linear sum may be replaced with a non-linear function, such as exponential function, to capture non-linear priority of a factor over other factors, for example:

$${E}_{index} = {\sum }_{i ∈ \{ factors \}} {w}_{i} {F}_{i} ( {G}_{i} ) \qquad ( 2 )$$

wherein Fᵢ(.) could be exp(.) for one factor and log(.) for another factor. The formulation may be further extended to F(G₁, G₂, . . . ; w₁, w₂, . . . ) function of Gᵢ that is parametrized by wᵢ. Examples include Equations (1) and (2).

In some embodiments, an estimating machine learning model may be used to estimate the node energy index based on the node performance data provided as input. In particular, a deep learning model may be trained to find optimal weights wᵢ. In this case, the value of contributing factors, such as particular node performance data, may be fed to a neural network as input, and the energy index is derived from the neural network as an output. The machine learning embodiments are advantageous where the node performance data that can be collected form the radio network nodes does not comprise parameters directly indicative of energy usage, so called energy counters, or when there are privacy/sharing constraints that prevent access to such counters.

A machine learning module, for example executing a deep neural network or some other deep learning technique, may predict energy consumption and consequently energy index of a radio network node based on other node performance data. For example, random access memory (RAM) utilization, central processing unit (CPU), hardware (HW) temperature may be used to derive an estimate of energy consumption or energy consumption rate relative to a reference value. A dataset of training samples may be collected, where the dataset may include temperature, disc occupation, CPU usage, device info, time, and location as features, and also the associated power/energy consumption. This dataset is then provided as input to train the model, which may be then used to infer the energy index.

In some other examples, generating the node energy index may comprise generating a first node energy index based on the obtained node performance data, for example for a 24 h time window. A predictive machine learning model (e.g. implementing a neural network based model) may then be trained, wherein the training is based on the first node energy index and the associated time window. In this way, the model may learn time-dependent patterns of values of energy indices for particular network nodes. Once the predictive machine learning model is trained with this data, the node energy index at some time window in future may be predicted using the trained predictive machine learning model.

The generated energy index may be normalized to take a value in a range between [0, 1]. The greater the value of the energy index, the more energy efficient the associated node is. In some embodiments, the node energy index may be calculated according to a formula obtained from a third party. The third party may be a utility provider, for example mains energy supplier that supplies energy used to power a particular radio network node.

In step 506, allocation of a computing task to a radio network node of the one or more radio network nodes is initiated. The allocation is based on the generated node energy index of all the participating radio network nodes. In some embodiments, the allocation may be performed in an allocating node 600, such as orchestrator node 306, 600 as part of OAM. In such a case, the generated node energy indices may be received 312, 534, 552 from the NWDAF 304.

In step 314, 554, the OAM 306, 600 may generate allocation of computing tasks, and once that is performed, send, in step 316, 536, the allocation back to the NWDAF 304. The NWDAF 304, may then send 318, 320, 322, 538 the computing tasks to respective NFs 302a, 302b, 302c along respective routing path for execution.

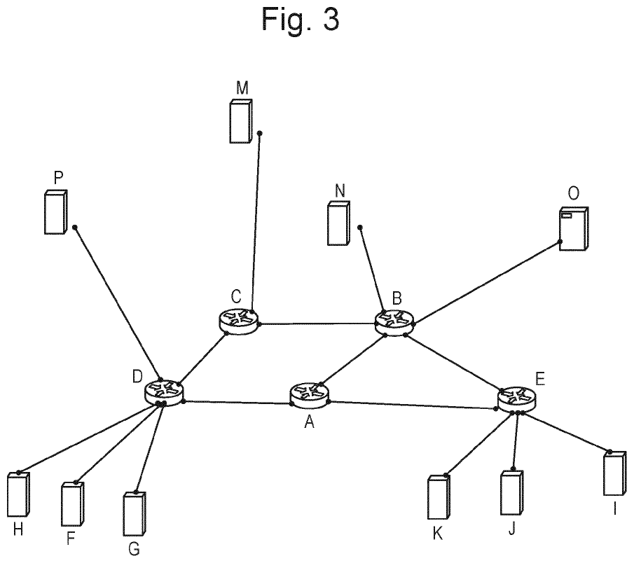

FIG. 3 illustrates example network topology. Furthermore, assume node B is an orchestrator node (may also be NWDAF) and has a computation task of load L to be delegated to neighboring nodes. We denote by tuple (X, P_{X}, L) allocation of load or computing task L to node X via communication path P_{X}. For example, tuples (P_{F}=(B→C→D→F); L₁) and (P_{K}=(B→A→E→K); L−L₁] represent a decision in which F, through (nodes B,C,D) path, and K (through nodes B,A,E) are doing L₁ and L−L₁ parts of the task. We further assume that the routing part (i.e., path selection) will be regularly updated by the routing layer and we have a path for every node to orchestrator (or NWDAF).

We also denote the computational capacity of node X by Z_{X} and its energy index by I_{X}. The aim is to derive optimal solutions based on the varying traffic volumes and energy cost profiles of radio network nodes. We have the following formulations:

$$arg {max}_{{L}_{X}} Utility function ( {L}_{X} ; {Z}_{X} , {I}_{X} for all X )$$

subject to (1) Σ_{X}L_{X}=L

### (2) Battery Criteria

In some embodiments, the utility function to be maximized is selected based on an intent representing aggregate operational goal to be reached by the communication network, such as “latency in the network to be maintained<value X”. The intent may be received by the orchestrator. For example, Application Function (AF) 307 may send 313 the intent to the OAM node 306. The intent may be dependent on use case and for example on a network slice in a network slicing configuration of a mobile network. For example, the utility function could be a network-wide utility such as minimum energy consumption in the entire network or for specific nodes such as minimum energy consumption of a particular set of nodes. In some examples, if energy bill is the focus of the operator of the communication network, then the orchestrator may prioritize the objective of lowering total energy usage. In some other non-limiting examples, carbon footprint or end-to-end latency of running the distributed learning service may be prioritized.

When the processing of the allocated computing task is to be powered by a battery in a radio network node, the battery level (e.g. expressed in State of Charge (SOC)) after running computations of L_{X} may be set to stay above a predefined minimum value. Furthermore, it is desirable that the load does not exceed the battery capacity Z_{X} (e.g. a set number of AHs). We denote by E_{X} the energy required to execute computation load L_{X} and communicate the results to the orchestrator, through path P_{X}, by B_{X} a binary variable of value “1” if and only if the computations of a radio network node by X are powered by a battery, by L_{X} the current battery level, and by

$${L}_{X}^{min}$$

the minimum permittable level for the battery. The battery constraints are therefore:

$${L}_{X} = 0 if {B}_{X} {E}_{X} > {Z}_{X} \qquad ( 2 - 1 )$$

$${L}_{X} = 0 if {L}_{X} - {B}_{X} {E}_{X} \geq {L}_{X}^{min} \qquad ( 2 - 2 )$$

In some examples, the utility function may comprise a weighted sum of the objectives, also called pareto scalarization technique, in the form of:

$$Utility function = {w}_{e} * EnergyBill + {w}_{n} * NodeCarbonFootprint$$

In this example, EnergyBill and/or NodeCarbonFootprint are given functions of the input parameters {L_{X}, Z_{X}, I_{X}} for all X. These functions may be obtained from a third party such as a utility provider. For example, the utility provider may give an equation/table for time-location dependent price of a unit of energy (kWh). The equation/table may then be used to calculate the total price of transmitting a task over a communication path and getting back the result. Similarly, when an equation, table or chart is available, for example from an infrastructure provider, to calculate NodeCarbonFootprint as a function of a task load, we can calculate the total carbon footprint of running a task and use that as a potential component of our final utility function.

In some examples, the utility function may be further parameterized with estimated energy consumption of the computing task to be allocated. For example, the orchestrator may have access to data on historical allocation and execution of computing tasks and associated parameters at a given state of assigned network node, such as energy consumption when executing the task. Using this data, the energy consumption of the task to be allocated may be estimated, for example through a training procedure of machine learning models.

Advantageously, some embodiments can reduce the energy consumption, including carbon footprint of executing distributed computation tasks, such as distributed AI training over a mobile network while respecting the requirements of the particular application use case and accuracy requirements associated with AI training. Advantageously, some embodiments optimise usage of stored energy supply, such as batteries, used to power the nodes executing the computing tasks. Advantageously, some embodiments address multiple factors that contribute to energy efficiency instead of just one such as communication efficiency. Advantageously, embodiments enable a more energy efficient allocation of computing tasks in a network. Advantageously, some embodiments enable a decrease of total energy consumption in the network. Advantageously, some embodiments enable more flexible prioritisation and usage of network resources that may be tailored to a particular objective, e.g. latency requirements or carbon footprint.

FIG. 5 shows a communication network 400 participating in a distributed machine learning setting. Distributed learning provides parallel computations, exploiting the communication capabilities between the involved network nodes. A distributed computation setting, such as Federated Learning (FL), is essentially iterative algorithm. FL aims at training a machine learning algorithm, for instance deep neural network, on multiple local datasets contained in local nodes without explicitly exchanging data samples. Local models are trained on local data samples and resulting parameters (e.g. the weights and biases of a deep neural network) are exchanged between these local nodes at some frequency to generate a global model shared by all nodes. The network 400 may comprise one or more NFs 402, NWDAF 404 and OAM 406. In step 408, the training task maybe registered across NF 402, NWDAF 404 and OAM 406. In step 410, OAM 406 may send initial settings to each NF, wherein the initial settings may comprise routing information, for example. In step 412, NWDAF 404 sends the allocated computing tasks to designated NFs 402. The computing task may be a global machine learning model and the information sent to NFs 402 along the global model may further comprise hyperparameters of the models to be used by the NF 402. In step 414, the NF 402 may execute the allocated computing task, e.g. train the received machine learning model on data local to the respective NF 402. Once the computing task is finished, the calculated local parameters such as weights of the trained model, may be uploaded, at step 416, to the NWDAF 404. The NF 402 may also upload changes in the node performance data influencing associated energy index. For example, if the traffic load has jumped due to some unforeseen event, the corresponding radio network node should get more power from the power grid which may reduce the energy index of that site. At step 418, the NWDAF may update the global model using the received weights from the NFs 402. In step 420, the NWDAF 404 reports the collected changes of the energy indices of the NFs to OAM 406. At step 422, the OAM 406 uses the reported changes from the NWDAF 404 to update the task allocation, that includes selecting a subset of NFs 402 to run the new iteration of distributed learning. The OAM 406 may also update the hyper-parameter settings (if any) of those NFs 402. To this end, OAM 406 solves optimization problem of maximising a particular utility function. The hyper-parameters may be different for different training algorithms and can be optimized using conventional hyper-parameter optimization techniques, such as grid search or Bayes search. Examples of hyper-parameters include “number of participants in every iteration” for FL or “mini-batch size” of distributed stochastic gradient. Once the updated task allocation and hyperparameters are ready, they are sent back, at step 424, 536, 556 to the NWDAF 404. Steps 412 to 424 may then be repeated.

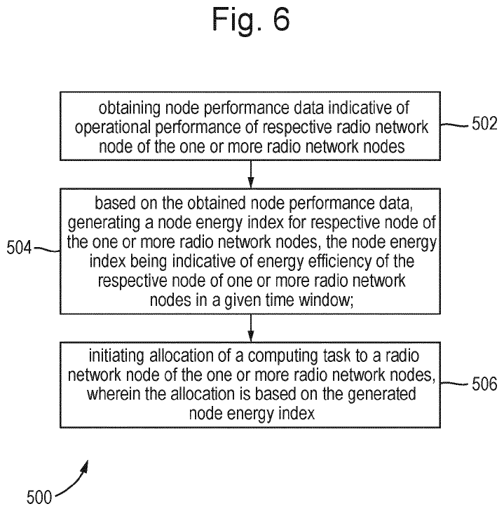

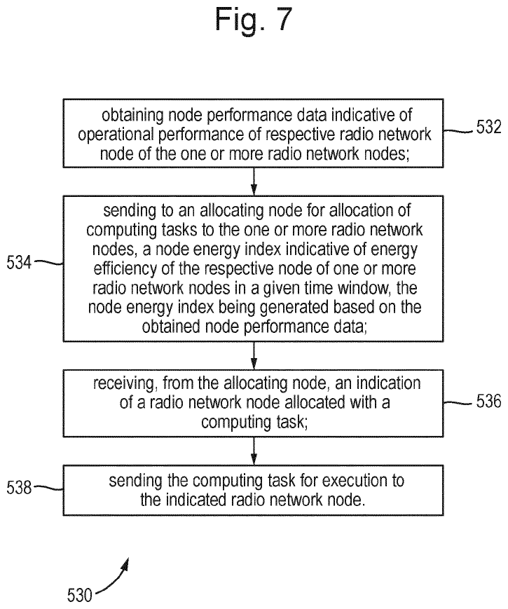

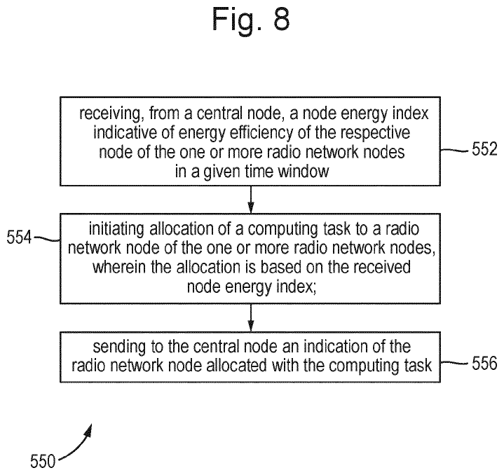

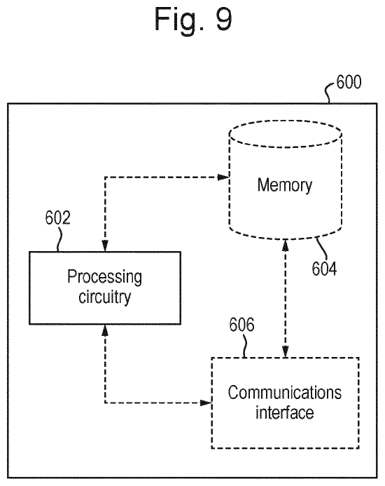

FIG. 9 is a schematic of an example of a network node 600, such as NF 302, 402, a central node (e.g. NWDAF 304, 404) or allocating node (e.g. orchestrator/OAM 306, 406), that may be configured to operate in a communication network 300, 400. The network node 600 may implement steps of the method 500, 530, 550, respectively. In particular, the network node 600 may comprise a processing circuitry 602 and a memory 604. Said memory 604 may contain instructions executable by said processing circuitry 602 whereby said node 600 is operative to perform steps of the methods 500, 530, 550 respectively. The network node 600 may, in some embodiments, be an electronic device that can be communicatively connected to other electronic devices on the network (e.g., other network devices, UEs, radio base stations, etc.). In certain embodiments, network node 600 may include radio access features that provide wireless radio network access to other electronic devices (for example a “radio access network device” may refer to such a network device) such as UEs. For example, network node 600 may be a base station, such as gNodeB in 5G, eNodeB in Long Term Evolution, LTE, NodeB in Wideband Code Division Multiple Access, WCDMA or other types of base stations, as well as a Radio Network Controller, RNC, a Base Station Controller, BSC, or other types of control nodes. As depicted in FIG. 6, the example network node 600 comprises processing circuitry or processor 602, memory 604, interface 606, and may also comprise antenna (not shown). These components may work together to provide various network device functionality as disclosed herein.

Processing circuitry 602 may be a microprocessor, controller, microcontroller, central processing unit, digital signal processor, application specific integrated circuit, field programmable gate array, any other type of electronic circuitry, or any combination of one or more of the preceding. The processor 602 may comprise one or more processor cores. In particular embodiments, some or all of the functionality described herein as being provided by network node 600 may be implemented by processor 602 executing software instructions, either alone or in conjunction with other network node 600 components, such as memory 604.

Memory 604 may store code (which is composed of software instructions and which is sometimes referred to as computer program code or a computer program) and/or data using non-transitory machine-readable (e.g., computer-readable) media, such as machine-readable storage media (e.g., magnetic disks, optical disks, solid state drives, read only memory (ROM), flash memory devices, phase change memory) and machine-readable transmission media (e.g., electrical, optical, radio, acoustical or other form of propagated signals-such as carrier waves, infrared signals). For instance, memory 604 may comprise non-volatile memory containing code to be executed by processor 602. Where memory 604 is non-volatile, the code and/or data stored therein can persist even when the network device is turned off (when power is removed). In some instances, while network node 600 is turned on that part of the code that is to be executed by the processor(s) 602 may be copied from non-volatile memory into volatile memory (e.g., dynamic random access memory, DRAM, static random access memory, SRAM) of network node 600.

Interface 606 may be used in the wired and/or wireless communication of signaling and/or data to or from network node 600. For example, interface 606 may perform any formatting, coding, or translating to allow network node 600 to send and receive data whether over a wired and/or a wireless connection. In some embodiments, interface 606 may comprise radio circuitry capable of receiving data from other devices in the network over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, interface 606 may comprise network interface controller(s), NICs, also known as a network interface card, network adapter, local area network, LAN adapter or physical network interface. The NIC(s) may facilitate in connecting the network node 600 to other devices allowing them to communicate via wire through plugging in a cable to a physical port connected to a NIC. As explained above, in particular embodiments, processor 602 may represent part of interface 606, and some or all of the functionality described as being provided by interface 606 may be provided more specifically by processor 602.

The components of network node 600 are each depicted as separate boxes located within a single larger box for reasons of simplicity in describing certain aspects and features of network node 600 disclosed herein. In practice however, one or more of the components illustrated in the example network node 600 may comprise multiple different physical elements (e.g., interface 606 may comprise terminals for coupling wires for a wired connection and a radio transceiver for a wireless connection).

While the modules are illustrated as being implemented in software stored in memory 604, other embodiments implement part or all of each of these modules in hardware.

The network node 600 may comprise a wireless or radio access node 600.

Although the interface 606, processing circuitry 602 and memory 604 are shown connected in series, these may alternatively be interconnected in any other way, for example via a bus.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method (500) for allocating computing tasks to one or more radio network nodes in a communication network, the method comprising:
obtaining (502) node performance data indicative of operational performance of respective radio network node of the one or more radio network nodes;
based on the obtained node performance data, generating (504) a node energy index for respective node of the one or more radio network nodes, the node energy index being indicative of energy efficiency of the respective node of one or more radio network nodes in a given time window;
initiating (506) allocation of a computing task to a radio network node of the one or more radio network nodes, wherein the allocation is based on the generated node energy index.

2. A method according to claim 1, wherein the node performance data comprises energy source data indicative of characteristics of energy source used to power the respective radio network node.

3. A method according to claim 2, wherein the energy source data comprises a battery and the characteristics comprise a battery capacity.

4. A method according to any preceding claim, wherein the node performance data comprises network traffic data associated with the respective radio network node.

5. A method according to any preceding claim, wherein the node performance data comprises configuration data associated with the respective radio network node.

6. A method according to any preceding claim, wherein generating the node energy index comprises calculating the node energy index according to a formula obtained from a third party.

7. A method according to any preceding claim, wherein generating the node energy index comprises providing the node performance data as input to an estimating machine learning model which estimates the node energy index based on the input.

8. A method according to any preceding claim, further comprising obtaining node computational capacity data of respective radio network node of the one or more radio network nodes, and wherein the allocation is further based on the obtained node computational capacity data.

9. A method according to claim 8, wherein the allocation of the computing task comprises maximising a utility function for the one or more radio network nodes, wherein the utility function comprises one or more of: the energy index, computing task, estimated energy consumption of the computing task and node computational capacity.

10. A method according to claim 9, further comprising obtaining an intent representing aggregate operational goal to be reached by the communication network, wherein the utility function is obtained based on the intent.

11. A method according to claims 9 to 10, wherein the utility function is obtained from a third party.

12. A method according to any preceding claim, wherein generating the node energy index comprises:
generating a first node energy index based on the obtained node performance data;
training a predictive machine learning model, wherein the training is based on the first node energy index and the associated time window; and
generating the node energy index using the trained predictive machine learning model, wherein the given time window for the node energy index is a future time window.

13. A method according to any preceding claim, wherein allocating a computing task comprises allocating a model training task of a plurality of model training tasks in a distributed machine learning system.

14. An apparatus (600) for allocating computing tasks to one or more radio network nodes in a communication network, the apparatus being configured to perform steps of the method according to any of the preceding claims.

15. An apparatus (600) for allocating computing tasks to one or more radio network nodes in a communication network, the apparatus comprising processing circuitry (602) and a memory (604), said memory containing instructions executable by said processing circuitry whereby said apparatus is operative to perform steps of the method according to any of the claims 1 to 13.

16. A communication network (300, 400) comprising:
one or more radio network nodes (302a, 302b, 302c, 402) configured to generate respective node energy index indicative of energy efficiency of the respective node in a given time window, wherein the node energy index is generated based on node performance data indicative of operational performance of respective radio network node;
an allocating node (304, 404) configured to obtain the node energy index, wherein the allocating node is further configured to initiate allocation of a computing task to a radio network node of the one or more radio network nodes, wherein the allocation is based on the obtained node energy index,
wherein, the allocating node is further configured to send to a central node (306, 406) an indication of the radio network node allocated with the computing task, wherein the central node is configured to receive from the allocating node the indication of the radio network node allocated with the computing task, wherein the central node is further configured to send the computing task for execution to the indicated radio network node.

17. A method (530) performed by a central node in a communication network comprising one or more radio network nodes, the method comprising:
obtaining (532) node performance data indicative of operational performance of respective radio network node of the one or more radio network nodes;
sending (534) to an allocating node for allocation of computing tasks to the one or more radio network nodes, a node energy index indicative of energy efficiency of the respective node of one or more radio network nodes in a given time window, the node energy index being generated based on the obtained node performance data;
receiving (536), from the allocating node, an indication of a radio network node allocated with a computing task;
sending (538) the computing task for execution to the indicated radio network node.

18. A method according to claim 17, wherein the node performance data comprises energy source data indicative of characteristics of energy source used to power the respective radio network node.

19. A method according to claim 18, wherein the energy source data comprises a battery and the characteristics comprise a battery capacity.

20. A method according to any of the preceding claims 17 to 19, wherein the node performance data comprises network traffic data associated with the respective radio network node.

21. A method according to any of the preceding claims 17 to 20, wherein the node performance data comprises configuration data associated with the respective radio network node.

22. A method according to any of the preceding claims 17 to 21, wherein generating the node energy index comprises calculating the node energy index according to a formula obtained from a third party.

23. A method according to any of the preceding claims 17 to 22, wherein generating the node energy index comprises providing the node performance data as input to an estimating machine learning model which estimates a value of the node energy index based on the input.

24. A method according to any of the preceding claims 17 to 23, further comprising obtaining node computational capacity data of respective radio network node of the one or more radio network nodes, and wherein the allocation is further based on the obtained node computational capacity data.

25. A method according to any of the preceding claims 17 to 24, wherein generating the node energy index comprises:
generating a first node energy index based on the obtained node performance data;
training a predictive machine learning model, wherein the training is based on the first node energy index and the associated time window; and
generating the node energy index using the trained predictive machine learning model, wherein the given time window for the node energy index is a future time window.

26. A central node (600) in a communication network comprising one or more radio network nodes, the central node being configured to perform steps of the method according to any of the preceding claims 17 to 25.

27. A central node (600) in a communication network comprising one or more radio network nodes, the central node comprising processing circuitry and a memory, said memory containing instructions executable by said processing circuitry whereby said apparatus is operative to perform steps of the method according to any of the preceding claims 17 to 25.

28. A method (550) performed by an allocating node in a communication network comprising one or more radio network nodes, the method comprising:
receiving (552), from a central node, a node energy index indicative of energy efficiency of the respective node of the one or more radio network nodes in a given time window,
initiating (554) allocation of a computing task to a radio network node of the one or more radio network nodes, wherein the allocation is based on the received node energy index;
sending (556) to the central node an indication of the radio network node allocated with the computing task.

29. A method according to claim 28, wherein the allocation of the computing task comprises maximising a utility function for the one or more radio network nodes, wherein the utility function comprises one or more of: the energy index, computing task, estimated energy consumption of the computing task and node computational capacity.

30. A method according to claim 29, further comprising obtaining an intent representing aggregate operational goal to be reached by the communication network, wherein the utility function is obtained based on the intent.

31. A method according to claims 29 to 30, wherein the utility function is obtained from a third party.

32. An allocating node (600) in a communication network comprising one or more radio network nodes, the allocating node being configured to perform steps of the method according to any of the preceding claims claim 28 to 31.

33. An allocating node (600) in a communication network comprising one or more radio network nodes, the allocating node comprising processing circuitry and a memory, said memory containing instructions executable by said processing circuitry whereby said apparatus is operative to perform steps of the method according to any of the preceding claims claim 28 to 31.

34. A computer program comprising instructions which, when executed on at least one processor, cause the at least one processor to carry out a method according to any of claims 1 to 13, 17 to 25, 28 to 31.

35. A computer program product comprising non transitory computer readable media having stored thereon a computer program according to any of the preceding claims 1 to 13, 17 to 25, 28 to 31.
